(19) United States
(12) Patent Application Publication
(10) Pub. No.: US 2010/0143171 A1
(43) Pub. Date: Jun. 10, 2010

(54) CONTROL DEVICE FOR A HYDRAULIC PISTON MACHINE WITH A VARIABLE FLOW RATE

(76) Inventors: Michael Gaumnitz, Horb (DE); Thomas Kunze, Neu-Ulm (DE)

Correspondence Address: MICHAEL J. STRIKER, 103 EAST NECK ROAD, HUNTINGTON, NY, 11743, US

(21) Appl. No.: 12/438,974

(22) PCT Filed: Jul. 3, 2007
(86) PCT No.: PCT/EP2007/005858

§ 371 Date: Feb. 5, 2010

(30) Foreign Application Priority Data
Sep. 1, 2006 (DE) 10 2006 041 086.6

(51) Int. Cl. F04B 39/08; F15B 13/044

(52) U.S. Cl. 417/505; 91/459

(57) ABSTRACT

The invention relates to a control device for a hydraulic piston machine which can be embodied as a hydropump or a hydromotor and the time-averaged volume flow of which is variable. The piston machine comprises a plurality of pistons, each delimiting a working chamber the volume of which varies with the stroke of a piston and which can be connected to a high pressure port via a first valve and to a low pressure port via a second valve. At least one of the two valves of a working chamber can be actively electrically actuated. The control device comprises an electronic control unit which operates the actively actuated valves of the working chambers in a partial stroke mode, in which only a varying portion of the piston stroke is utilized. In order to reduce the control complexity, the actively actuated valves can be operated in not more than two different modes, namely either only in the partial stroke mode or in the partial stroke mode and an idle stroke mode or in the partial stroke mode and a complete stroke mode or all three modes can only be applied to a limited number of working chambers and only the idle stroke mode and the complete stroke mode to the remaining working chambers.

The invention is based on a control device according to the preamble to claim 1, 2, 3, or 4. The control device is provided for controlling a hydraulic piston machine, which can be embodied as a hydraulic pump or hydraulic motor and has a variable flow rate averaged over time. The piston machine has a plurality of pistons that each define a respective working chamber whose volume changes with the stroke of a piston and that can be connected to a high-pressure connection via a first valve and to a low-pressure connection via a second valve. At least one of the two valves of a working chamber can be actively actuated in an electric fashion. The control device includes an electronic control unit that is able to operate the actively actuatable valves of the working chambers in a partial stroke mode in which only a varying-sized portion of the piston stroke is used.

A control device of this kind is known from EP 1 537 333 B1. In it, the working chambers and pistons can be operated in an idle stroke mode in which the piston stroke is not used, in the above-mentioned partial stroke mode in which only a portion of the piston stroke is used, and in a full stroke mode in which the full piston stroke is used. It goes without saying that with a zero flow rate, all of the pistons are operated in the idle stroke mode and with a maximum flow rate, all of the pistons are operated in the full stroke mode. The cited reference also explains that starting from a flow rate of zero, at a low flow rate, the operating sequence is composed of the partial stroke mode and idle stroke mode and as the required flow rate increases, the proportion of the partial stroke mode in relation to the idle stroke mode increases. As the flow rate continues to increase, the control device inserts full strokes from time to time between idle and partial strokes. Starting from the maximum flow rate, as the required flow rate decreases, idle strokes are inserted between the full strokes. Below a fixed or variable threshold, the control device begins to mix idle stroke mode, partial stroke mode, and full stroke mode. A control of this kind requires computation of considerable complexity and a considerable amount of computing power.

The object of the invention is to find a control device for a hydraulic piston machine, having a variable flow rate averaged over time, having the other defining characteristics from the preamble to claim 1 in which the control algorithm is not too complex, and featuring a lower degree of programming complexity and a lower requirement of computing power and for which more reasonably priced electronics can be used.

The stated object is attained in a first way according to the characterizing part of claim 1 in that the actively actuatable valves are operable only in the partial stroke mode. In the control device known from EP 1 537 333 B1, at a flow rate that lies between zero and the maximum flow rate of the piston machine, in addition to the partial stroke mode, at least one other mode is used; by contrast, according to the first variant of the invention, only the partial stroke mode is used. The zero flow rate and maximum flow rate therefore represent borderline cases of the partial stroke mode.

The stated object is attained in a second way according to the characterizing part of claim 2 in that the actively actuatable valves are operable only in the partial stroke mode and the idle stroke mode. This means that at a flow rate that is less than the maximum flow rate, none of the pistons executes a full useful stroke. Only when the maximum flow rate is required do all of the pistons execute full useful strokes, but these must be considered borderline cases of the partial stroke mode.

The stated object is attained in a third way according to the characterizing part of claim 3 in that the actively actuatable valves are operable only in the partial stroke mode and the full stroke mode. This means that at a flow rate that is greater than zero, none of the pistons executes an idle stroke. Only when no flow rate is required do all of the pistons execute full idle strokes. However, this must be considered a borderline case of the partial stroke mode.

Finally, the stated object is attained in a fourth way according to the characterizing part of claim 4 in that all three modes are used on only a limited number of working chambers and only the idle mode and full stroke mode are used on the remaining working chambers.

In an advantageous embodiment of the control device according to claim 4, according to claim 5, all three modes are used only on every other working chamber and/or according to claim 6, all three modes are always used on the same working chambers.

According to claim 7, the electronic control unit makes a new respective selection of the mode in successive cycles of the piston machine and in the partial stroke mode, makes a new respective selection of the useful stroke of a piston. By contrast, the computing complexity can be reduced if according to claim 8, once the mode has been selected for a working chamber, it is maintained over the course of at least two successive cycles of the piston machine. With an operation in partial stroke mode, the height of the useful stroke here is also advantageously maintained over the course of at least two successive cycles of the piston machine. This admittedly applies primarily only as long as the flow rate remains constant. It can differ if the flow rate changes.

Particularly according to claim 1, if an operation is provided only in the partial stroke mode, then preferably all of the pistons are respectively operated in the same way, i.e. with the same magnitude of useful stroke. This means that with a constant flow rate per machine cycle, all of the active pistons contribute the same subset of the total flow rate and no one active piston delivers or draws more than another active piston. Basically, even with a changing flow rate over the course of a machine cycle, the subsets of all pistons can be the same and can change from cycle to cycle. For purposes of a rapid adaptation of the flow rate, however, it turns out to be more advantageous to change the subsets within a machine cycle.

Two exemplary embodiments of a piston machine controlled according to the present invention are shown in the drawings. The invention will now be explained in greater detail in conjunction with these drawings.

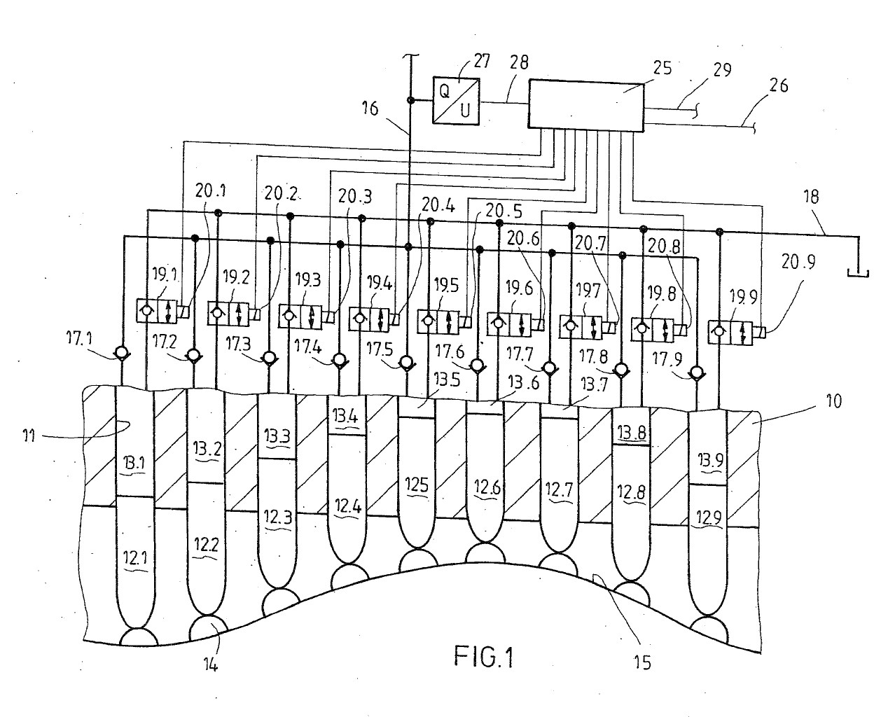

FIG. 1 is a developed view of a piston housing of an axial piston pump with nine pistons and an actively controlled suction valve as well as the associated control unit, and

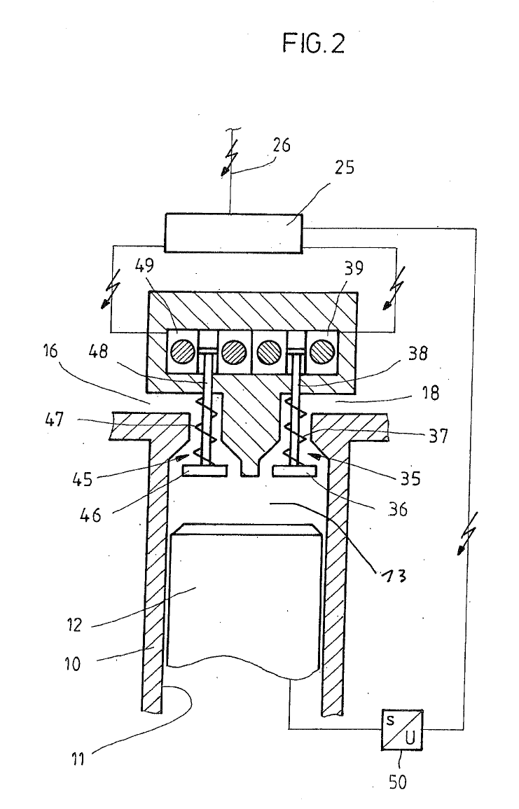

FIG. 2 is a detail of a second piston machine, which can be operated as a pump and as a motor and in which each working chamber has an inlet valve and an outlet valve that are actively controllable.

According to FIG. 1, an axial piston pump has a stationary housing part 10 that has nine blind bores 11 distributed uniformly around a central axis. A piston 12.n (n=1 through 9) travels into each blind bore 11 and delimits a working chamber 13.n (n=1 through 9) therein, whose volume changes when the piston traveling in it moves in the axial direction of the blind bore. Each piston 12.n is supported via a piston shoe 14 against an inclined surface 15 of a swash plate, not shown in detail, which is affixed to a shaft that is likewise not shown. So that the piston shoes remain securely resting against the inclined surface 15, a spring can be provided for each piston, which presses the piston shoe against the swash plate with a certain force.

Between each working chamber 13.n and a pressure line 16 connected to the axial piston pump and shared by all of the working chambers, a check valve 17.n (n=1 through 9) that closes toward the working chamber is provided, which functions as the pressure valve of a working chamber. All of the pressure valves are controlled solely by the pressure difference between the respective working chamber and the pressure line and an optionally provided weak spring acting in the closing direction, i.e. are controlled in a purely passive fashion. Since a pressure fluid flow is therefore permitted only from a working chamber into the pressure line, the machine depicted is a hydraulic pump, as has already been stated.

Between each working chamber 13.n and a tank line 18 connected to the axial piston pump and shared by all of the working chambers, a check valve 19.n (n=1 through 9) that opens toward the working chamber is provided, which functions as the suction valve of a working chamber. Each suction valve is associated with an electromagnet 20.n (n=1 through 9) by means of which the suction valve can be kept open in a directly or electrohydraulically pilot-controlled fashion. The suction valves are therefore actively controlled valves.

They are controlled by means of an electronic control unit 25 that receives, via an input line 26, a setpoint value for the magnitude of the flow rate in the pressure line 16. This pressure line 16 has an electrical sensor 27 connected to it, which detects the magnitude of the flow rate in the pressure line and sends a corresponding signal to the control unit 25 via a line 28. The control unit also receives, via a line 29, a signal that corresponds to the angle of rotation of the swash plate and/or the drive shaft of the hydraulic pump. The speed of the hydraulic pump is also determined through differentiation on the basis of this signal. A control line 30.n (n=1 through 9) leads from the control unit to each electromagnet 20.n.

In the hydraulic pump according to FIG. 1, if the suction valves 19.n are not actively controlled, then the delivery quantity depends solely on the speed. If a piston 12.n moves out of a blind bore in the intake stroke, then the volume of the corresponding working chamber 13.n increases. The suction valve 19.n opens and pressure fluid flows out of the tank line 18 into the working chamber. At the bottom dead center, the movement direction of the piston reverses and the volume of the working chamber decreases in the subsequent delivery stroke. The pressure in the working chamber increases until the pressure valve 17.n opens. Then pressure fluid is displaced into the pressure line 16 via the pressure valve until the top dead center is reached. The delivery volume of the hydraulic pump, i.e. the delivery quantity per rotation, is at its maximum.

In order to reduce the delivery volume of the hydraulic pump, then in a first control variant, starting from the bottom dead center of each piston, the suction valves 19.n of all of the working chambers 13.n are kept open through a triggering of the corresponding electromagnet 20.n for a certain angle of rotation of the swash plate and thus for a certain stroke of the piston. Consequently, at first, each piston displaces a portion of the pressure fluid in the working chamber into the tank line 18 in a largely unpressurized fashion via the open suction valve. The electromagnets can be supplied with voltage at any time during the movement of the associated piston from the top dead center to the bottom dead center since the suction valves are open during this piston movement anyway. By contrast, the de-energizing of the electromagnets must take place taking into account the speed at precisely the stroke of a piston adapted to the desired delivery quantity. The lower the delivery quantity is to be, the longer the suction valves 19.n are kept open until finally, at a zero delivery quanty, they are no longer closed at at all.

In a second control variant, in order to reduce the delivery volume of the hydraulic pump starting from the maximum delivery volume, in a pump cycle, i.e. within one rotation of the swash plate, the suction valves 19.n of a portion of the working chambers 13.n are kept open for the entire delivery stroke of a piston 12.n. These working chambers are operated in the idle stroke mode. The suction valves 19.n of the other working chambers 13.n are kept open starting from the bottom dead center of the corresponding pistons only for a certain angle of rotation of the swash plate and thus for a certain stroke of the piston through triggering of the corresponding electromagnet 20.n. These working chambers are operated in the partial stroke mode. With the same delivery quantity, in the second control variant, the useful stroke of the pistons operated in the partial stroke mode is naturally greater than in the first control variant so that the electromagnets are de-energized closer to the bottom dead center of the pistons operated in partial stroke mode and the corresponding suction valves close closer to the bottom dead center. With the reduction of the delivery quantity, the number of pistons per pump cycle that are operated in the idle stroke mode increases continuously until finally, at a delivery quantity of zero, all of the pistons are in the idle stroke mode.

In a third control variant, in order to reduce the delivery volume of the hydraulic pump starting from the maximum delivery volume, in one pump cycle, i.e. within one rotation of the swash plate, the suction valves 19.n of a portion of the working chambers 13.n remain closed over the course of the entire delivery stroke of a piston 12.n. These working chambers are operated in the full stroke mode. Starting from the bottom dead center of the corresponding pistons, the suction valves 19.n of the other working chambers 13.n are kept open for only a certain angle of rotation of the swash plate and thus for a certain stroke of the piston through triggering of the corresponding electromagnet 20.n. These working chambers are operated in the partial stroke mode. With the same delivery quantity, in the third control variant, the useful stroke of the pistons operated in the partial stroke mode is naturally smaller than in the first control variant so that the electromagnets are de-energized farther away from the bottom dead center of the pistons operated in the partial stroke mode and the corresponding suction valves close farther away from the bottom dead center.

In a fourth control variant, in order to reduce the delivery volume of the hydraulic pump starting from the maximum delivery volume, in one pump cycle, i.e. within one rotation of the swash plate, all three operating modes, namely the idle stroke mode, partial stroke mode, and full stroke mode, are used on only a limited number of working chambers while the remaining working chambers are operated only in the idle stroke mode and the full stroke mode. For example, depending on the delivery quantity demand at a given moment, in each pump cycle for the pistons 12.1, 12.3, 12.5, 12.7, and 12.9, all three modes are used and for the pistons 12.2, 12.4, 12.6, and 12.8, only the idle stroke mode in which a suction valve is open for the entire delivery stroke of a piston and the full stroke mode in which a suction valve is closed for the entire delivery stroke of a piston are possible. It would also be conceivable, over the course of the cycles, for every nth—e.g. every second—piston, for example, to be operated in all three modes or only in the idle stroke mode or the full stroke mode. For example, in one cycle, all three modes would be possible for the pistons 12.1, 12.3, 12.5, 12.7, and 12.9 and only the idle stroke mode and full stroke mode would be possible for the pistons 12.2, 12.4, 12.6, and 12.8 and in the next cycle, all three modes would be possible for the pistons 12.2, 12.4, 12.6, and 12.8 and only the idle stroke mode and full stroke mode would be possible for the pistons 12.1, 12.3, 12.5, 12.7, and 12.9. If in general, the operation of every nth piston is possible only in the idle stroke mode and full stroke mode, then the sequence of the pistons that can be operated in the various modes is the same over the course of the cycles if the total number of pistons is a whole-number multiple of n.

Once a mode has been selected, it can also be maintained over the course of at least two successive pump cycles. For a piston operated in the partial stroke mode, the useful stroke can likewise be maintained over the course of at least two pump cycles.

FIG. 2 shows one of the several pistons 12 of a radial or axial piston machine, which can travel different distances into a blind bore 11 of a housing part 10 and delimits a working chamber 13 therein, whose volume changes when the piston traveling in it moves in the axial direction of the blind bore.

Between the working chamber 13 and a low-pressure line 18, an outlet valve 35 embodied in the form of a seat valve is provided, which has a disk-like closing element 36, which is loaded in the opening direction by a weak helical compression spring 37. If the pressure in the working chamber is greater than the pressure in the low-pressure line 18 by at least the pressure equivalent of the compression spring 37, then the pressure difference closes the outlet valve 35. The compression spring 37 encompasses a slider 38 that is affixed to the armature of an electromagnet 39. When the electromagnet 39 is excited, it assists the compression spring 37 in holding open the outlet valve 35.

Between the working chamber 13 and a high-pressure line 16, an inlet valve 45 is provided, which is embodied in a fashion very similar to that of the outlet valve 35 and likewise has a disk-like closing element 46 that is loaded in the opening direction by a weak helical compression spring 47. The compression spring 47 encompasses a slider 48 that is affixed to the armature of an electromagnet 49. When the electromagnet 49 is excited, it closes the inlet valve 45 in opposition to the force of the compression spring 47 and in opposition to a pressure difference between the pressure in the pressure line and the pressure in the working chamber.

The two electromagnets 39 and 49 are triggered by an electronic control unit 25 that receives via the line 26, among other things, a setpoint value for a speed of the hydraulic motor and a signal from a position sensor 50 that detects the position of the piston 12 in the blind bore 11 directly or indirectly, for example via the angle of rotation of an output shaft.

A machine according to FIG. 2 can be operated as a hydraulic motor with a variable displacement. In an operation at a maximum displacement, the inlet valve is open during the entire movement of the piston 12 from the top dead center, in which the working chamber is at its smallest, to the bottom dead center, in which the working chamber is at its largest. At the top dead center, the outlet valve is closed by the increasing pressure in the working chamber after the opening of the inlet valve. At the bottom dead center or shortly before the bottom dead center is reached, the electromagnet 49 is excited and the inlet valve 45 is therefore closed. The outlet valve 35 is opened through excitation of the electromagnet 39 and kept open so that with the subsequent upward motion, the piston can displace the pressure fluid contained in the working chamber 13 into the low-pressure line via the outlet valve 35. In other words, the piston here is operated in the full stroke mode.

In an operation of the hydraulic motor with a displacement that is less than the maximum, the electromagnet 49 is already excited and therefore the inlet valve 45 is closed even before the piston 12 has reached the bottom dead center. The pressure in the working chamber 13 drops as a result of the further movement of the piston 12 so that the outlet valve 35 opens and during the path of the piston 12 to the bottom dead center, a replenishing flow of pressure fluid is drawn into the working chamber 13 from the low-pressure line 18. The electromagnet 39 is excited at the bottom dead center of the piston 12 at the latest so that the outlet valve 35 remains open during the subsequent upward movement of the piston 12. The piston here is therefore operated in the partial stroke mode.

If the inlet valve 45 remains closed and the outlet valve 35 remains open during the entire movement of the piston 12 from the top dead center to the bottom dead center and back to the top dead center, then this is an operation in the idle stroke mode.

As described above in connection with FIG. 1, in the hydraulic motor according to FIG. 2, it is also possible in a first control variant for all of the pistons 12 to be operated in the partial stroke mode.

In a second control variant, the pistons are operated only in the partial stroke mode and the idle stroke mode.

In a third control variant, the pistons are operated only in the partial stroke mode and the full stroke mode.

In the fourth control variant, all of the modes, i.e. the idle stroke mode, the partial stroke mode, and the full stroke mode, are used on only a limited number of working chambers while the remaining working chambers are operated only in the idle stroke mode and the full stroke mode.

The piston machine according to FIG. 2 can also be used as a hydraulic pump. To that end, in the different modes, the electromagnet 39 and the outlet valves 35 are triggered in precisely the same way as the valves 19.n in FIG. 1. The outlet valves 35 are therefore kept open over the entire path of a piston from the bottom dead center to the top dead center (idle stroke), over a portion of the path (partial stroke), or not at all (full stroke). Whenever the outlet valve is kept open during the delivery stroke and during the entire intake stroke of a piston 12, the inlet valve 45 must be kept closed through excitation of the electromagnet 49.

Naturally, in a variant of the piston machine according to FIG. 2, the two valves 35 and 45 can also be embodied so that the compression springs 37 and 47 act on the closing element in the closing direction.

The outlet side and the inlet side can also be exchanged with each other, in which case the line 18 would be the high-pressure line and the line 16 would be the low-pressure line. The behavior of the machine is the same in both cases since the two valves 35 and 45 are the same and are arranged in the same fashion.

It would also be conceivable, however, to embody the valve on the high-pressure side inversely to the valve on the low-pressure side. The associated electromagnet then would not have to switch and hold the valve under strain, i.e. in opposition to the high pressure, and could therefore be embodied as correspondingly weaker. However, the machine would no longer be invariant in the event that the high-pressure and low-pressure lines were exchanged with each other.

What is claimed is:

1. A control device for a hydraulic piston machine, having a variable flow rate averaged over time, having a plurality of pistons (12) that each define a working chamber (13) whose volume changes with the stroke of a piston (12) and that is connectable to a high-pressure line (16) via a first valve (17, 45) and to a low-pressure line (18) via a second valve (19, 35), with at least one of the two valves of a working chamber being actively actuatable in an electric fashion, and having an electronic control unit (25) that is able to operate the actively actuatable valves (19, 35, 45) of the working chambers (13) in a partial stroke mode in which only a portion of the piston stroke is used,
wherein the actively actuatable valves (19, 35, 45) are operable only in the partial stroke mode.

2. A control device for a hydraulic piston machine, having a variable flow rate averaged over time, having a plurality of pistons (12) that each define a working chamber (13) whose volume changes with the stroke of a piston (12) and that is connectable to a high-pressure line (16) via a first valve (17, 45) and to a low-pressure line (18) via a second valve (19, 35), with at least one of the two valves of a working chamber being actively actuatable in an electric fashion, and having an electronic control unit (25) that is able to operate the actively actuatable valves (19, 35, 45) of the working chambers (13) in an idle stroke mode in which the piston stroke is not used and a partial stroke mode in which only a portion of the piston stroke is used,
wherein the actively actuatable valves (19, 35, 45) are operable only in the partial stroke mode and in the idle stroke mode.

3. A control device for a hydraulic piston machine, having a variable flow rate averaged over time, having a plurality of pistons (12) that each define a working chamber (13) whose volume changes with the stroke of a piston (12) and that is connectable to a high-pressure line (16) via a first valve (17, 45) and to a low-pressure line (18) via a second valve (19, 35), with at least one of the two valves of a working chamber being actively actuatable in an electric fashion, and having an electronic control unit (25) that is able to operate the actively actuatable valves (19, 35, 45) of the working chambers (13) in a partial stroke mode in which only a portion of the piston stroke is used and a full stroke mode in which the full piston stroke is used,
wherein the actively actuatable valves (19, 35, 45) are operable only in the partial stroke mode and in the full stroke mode.

4. A control device for a hydraulic piston machine, having a variable flow rate averaged over time, having a plurality of pistons (12) that each define a working chamber (13) whose volume changes with the stroke of a piston (12) and that is connectable to a high-pressure line (16) via a first valve (17, 45) and to a low-pressure line (18) via a second valve (19, 35), with at least one of the two valves of a working chamber being actively actuatable in an electric fashion, and having an electronic control unit (25) that is able to operate the actively actuatable valves (19, 35, 45) of the working chambers (13) in an idle stroke mode in which the piston stroke is not used, a partial stroke mode in which only a portion of the piston stroke is used, and a full stroke mode in which the full piston stroke is used,
wherein all three modes are used on only a limited number of working chambers (13) and only the idle stroke mode and the full stroke mode are used on the remaining working chambers.

5. The control device as recited in claim 4,
wherein all three modes are used only on every other working chamber (13).

6. The control device as recited in claim 4,
wherein all three modes are always used on the same working chambers (13).

7. The control device as recited in claim 1,
wherein the electronic control unit (25) makes a new respective selection of the mode in successive cycles of the piston machine and in the partial stroke mode, makes a new respective selection of the useful stroke of a piston (12).

8. The control device as recited in claim 1,
wherein once the mode has been selected for a working chamber (13), it is maintained over the course of at least two successive cycles of the piston machine.

9. The control device as recited in claim 8,
wherein during an operation of a working chamber (13) in the partial stroke mode, the height of the useful stroke is maintained over the course of at least two successive cycles of the piston machine.
